(19) United States
(12) Patent Application Publication
(10) Pub. No.: US 2006/0107805 A1
(43) Pub. Date: May 25, 2006

(54) Apparatus for trimming paper rolls or logs and method for treating the logs

(76) Inventor: Fabio Perini, Viareggio (IT)

Correspondence Address: McGlew and Tuttle, Scarborough Station, Scarborough, NY, 10510-0827, US

(21) Appl. No.: 10/524,001

(22) PCT Filed: Jul. 25, 2003
(86) PCT No.: PCT/IT03/00458

§ 371 Date: Oct. 12, 2005

(30) Foreign Application Priority Data
Aug. 9, 2002 (IT) FI2002A000155

(51) Int. Cl. B26D 1/00; B26D 7/06

(52) U.S. Cl. 83/13; 83/407; 83/409

(57) ABSTRACT

Apparatus for trimming paper rolls or logs (2) characterized in that it comprises:—a section for the entry of he logs 82) to be trimmed,—a section for the exit of the trimmed logs (2′);—a station with cutting means (6) for trimming the logs (2);—means (3) for moving the logs (2, 2′) between said entry section, said cutting station and said exit section;—means (4), associated with said log-moving means (3), for retaining the logs when subjected to said movement.

The present invention refers to an apparatus for trimming paper rolls or logs and to an operating method for treating the logs.

In the description that follows, the term paper rolls and, its equivalent term “logs” refer to rolls of web material (such as paper) wound up around a support core (e.g. a cardboard tubular core) to be cut in order to form rolls of smaller dimensions, that is, of commercial size.

The current production of small rolls of paper is known to include cutting transversally the logs produced by a rewinding machine and with the use of one o more cutting-off machines.

A cutting-off machine for logs is described in details in the document IT 1247330.

In practice, a cutting-off machine of this type includes:

a plurality of channels or guides into which the logs are unloaded, and in correspondence of which movable devices, so-called “porters”, are mounted and operated for moving longitudinally the logs by pushing them from the back;

a cutting station, comprising one or more circular blades rotating about axes parallel to those of the logs and fixed onto a corresponding movable support;

means for discarding the waste, that is, the end trims produced in said cutting station.

During the normal operation, a log to be cut is disposed by a relevant porter unit in a preset position onto the respective guide, the same log is retained in such position, and one of the blades is operated, that is, is driven in a plane orthogonal to the log's axis, so as to form a shorter roll of preset size. The length of the small roll depends actually on the advancement of the porter unit during the time elapsing between two consecutive actuations of the blades.

The current production processes imply some degree of inaccuracy in the formation of the logs. In fact, the cores are likely either to project from the ends of the wound-up material or to result thereinside. Moreover, the end bases of the logs may result oblique with respect to the longitudinal axes thereof and their consistence may lack in uniformity.

In conclusion, the length of the logs is never the same, both owing to said process irregularities and to the deformations induced by the pressure exerted by the porter units onto poor-consistence bases of the logs, which deformations bring about errors in the advancement of the porter units and are thus cause of inaccuracy on the lengths of the small rolls formed from the logs. Such inaccuracies result crucial when the cuts must be made at preset distances from printed pictures or other imprint figures formed on the paper of the logs.

Besides, the first and the last cuts, required for trimming the logs in correspondence of their two ends, generate waste or trims which must be detached from the small rolls before putting the latter on the market. Provision is made therefore for using means intended to separate the trims, which means are never totally efficient and their intervention is likely to prejudice the quality of the small rolls.

A further drawback related to this log-trimming technique lies in the poor quality of the trimming cuts: in order to keep the production waste at a minimum, the lenght of the trims is minimal but, owing to the lack of homogeneity of the material close to the end bases, the corresponding cuts are hardly ever orthogonal to the axis of the logs, so that, most of the times, for each log there are produced two imperfect small rolls (one for each end of the log), also due to the high cutting speed and to the shape, of the chamfer of the blades. The result is that, generally, the adopted solution is a trade-off which fulfills only in part the requirements for the trimming and cutting-off of the logs.

The main object of the present invention is to overcome the said drawbacks.

This result has been achieved, according to the invention, by adopting the principles set forth in the independent claims. Further characteristics being disclosed in the dependent claims.

The present invention makes it possible to simplify and improve the log-cutting process. Moreover, it allows to simplify the structure and operation of the cutting-off machines, as the section for the removal of the trims from the logs is unnecessary and, accordingly, it ca be suppressed. In addition to this, the apparatus according to the invention is easy to make, cost-effective and reliable even after a prolonged service life.

These and other advantages and characteristics of the invention will be best understood by anyone skilled in the art from a reading of the following description in conjunction with the attached drawings given as a practical exemplification of the invention, but not to be considered in a limitative sense, wherein:

Figs. show different positions of an apparatus according to the invention within a plant for the production of paper rolls of commercial size;

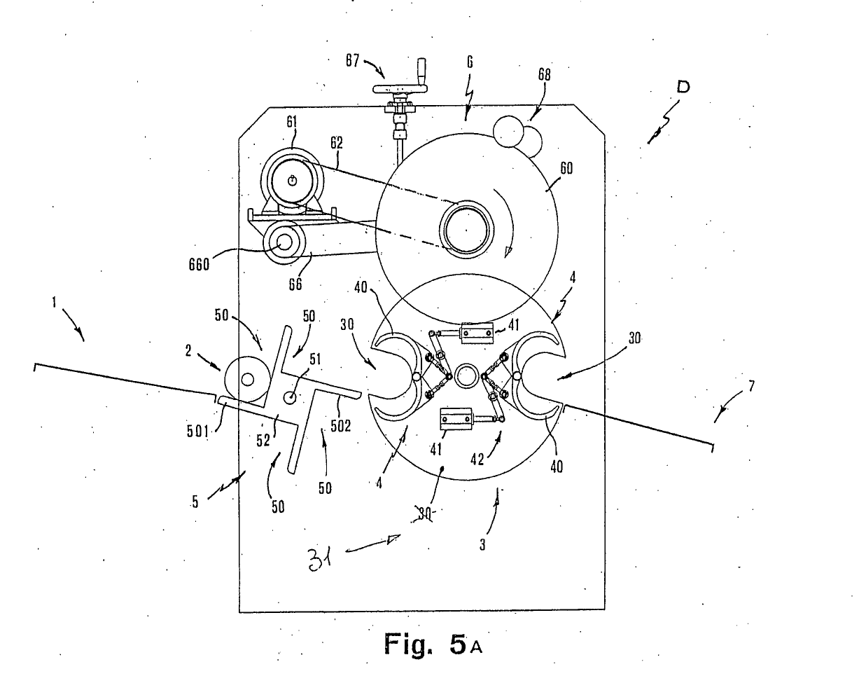

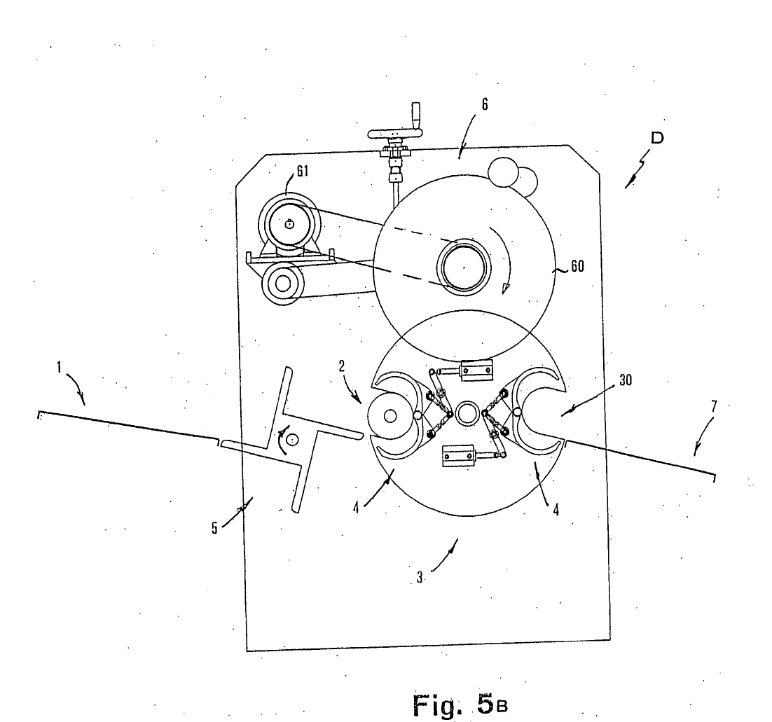

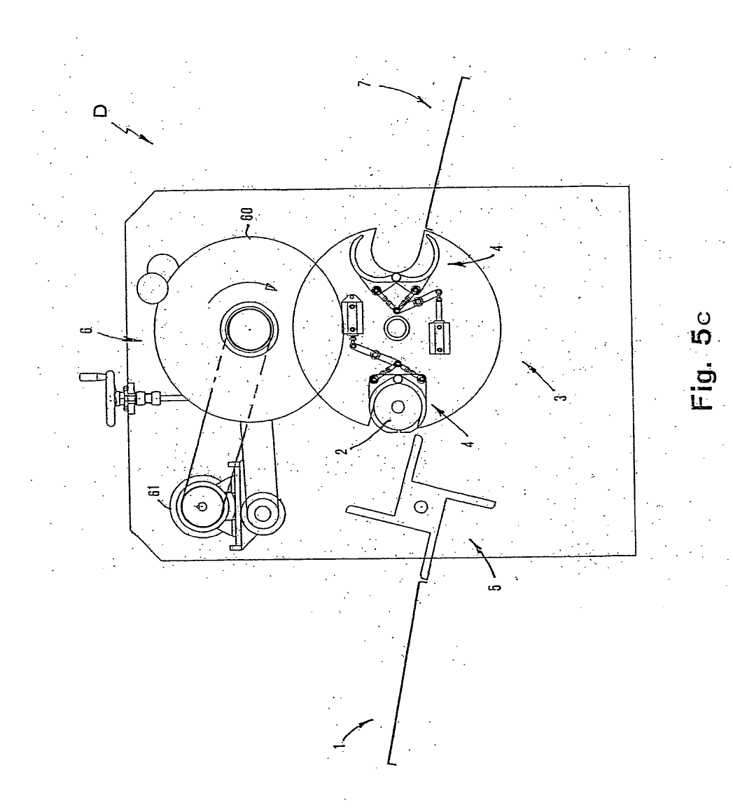

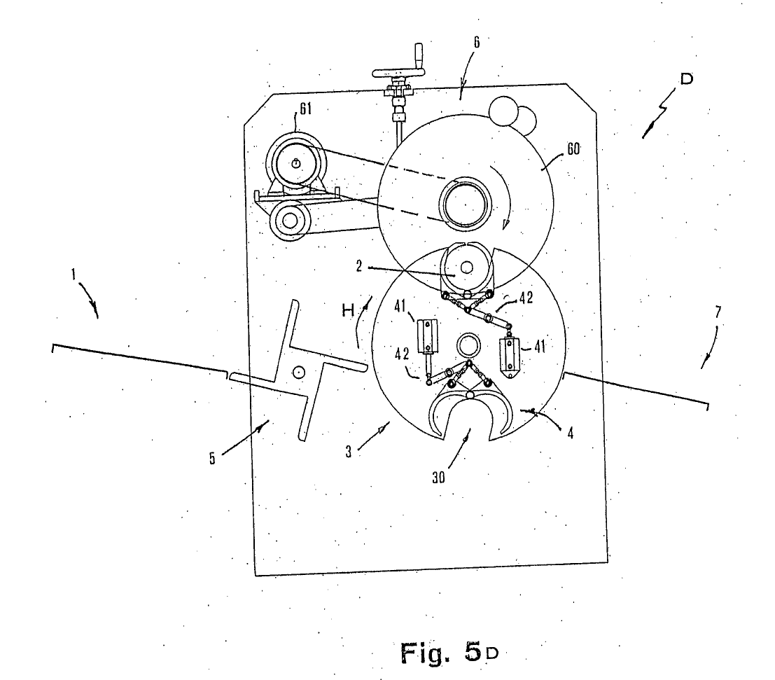

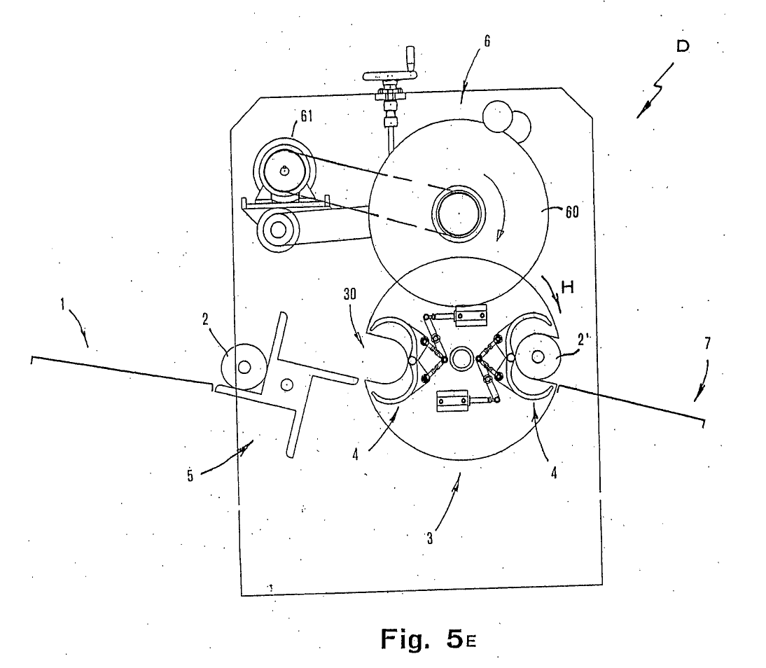

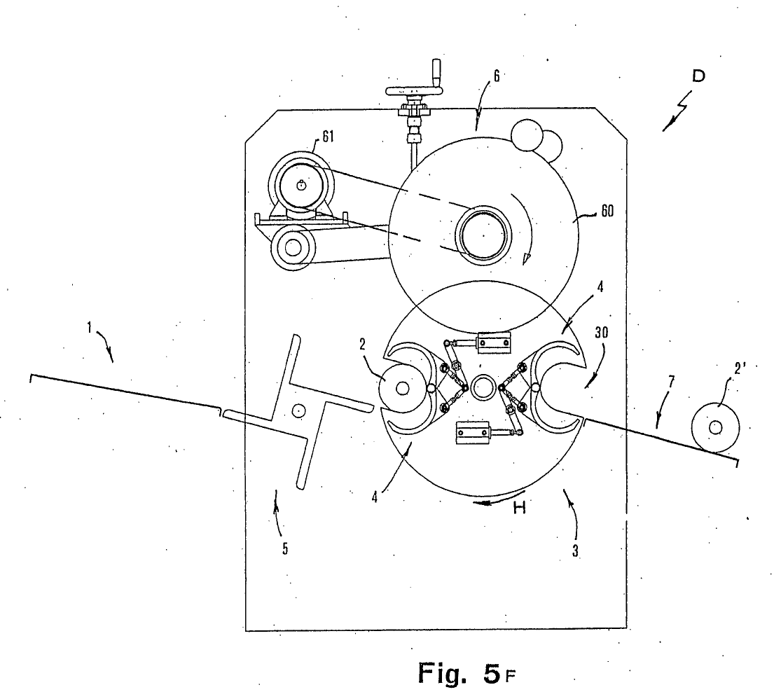

FIGS. 5A-5F are schematic side views in phantom of an apparatus according to the invention in a plurality of corresponding operating states;

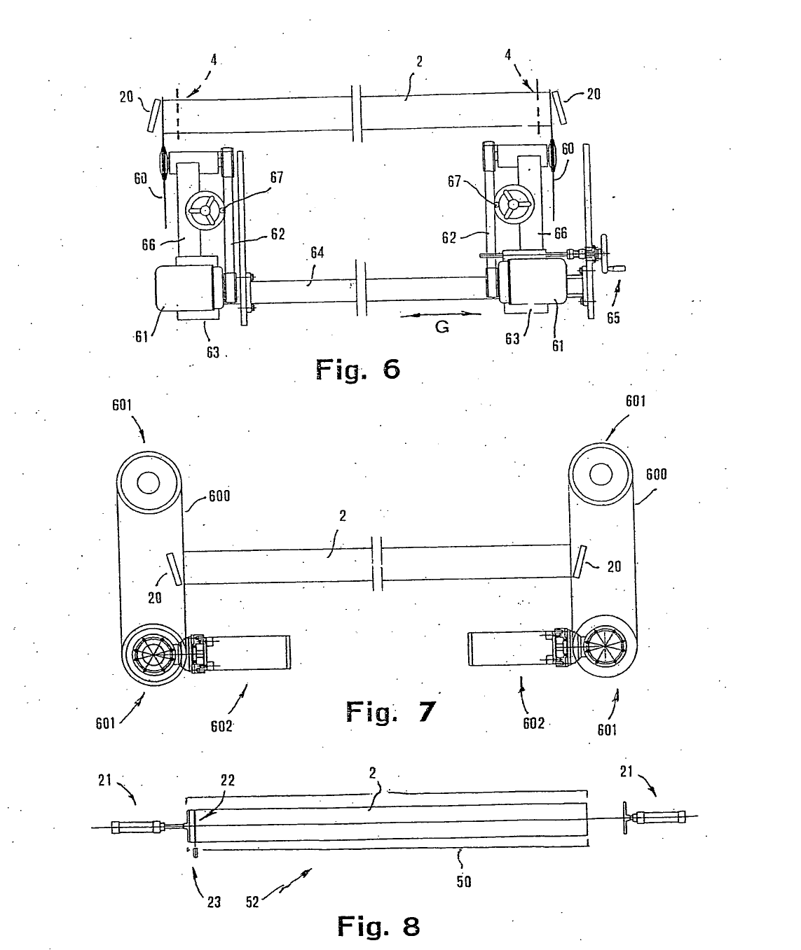

FIG. 6 is a schematic plan view of an apparatus according to the invention;

FIG. 7 is a view similar to that of FIG. 6, relating to an alternative embodiment of the invention;

FIG. 8 shows a schematic diagram relating to a step of longitudinal pre-positioning of a log.

Reduced to its basic structure, and reference being made to the FIGS. 5A-5F of the attached drawings, an apparatus (D) according to the invention comprises:

A plane (1) for the entry of logs (2) produced upstream of a rewinder (R);

a revolving unit (3) comprising a plurality of housings (30) for the logs (2) which come one at a time from said entry plane (1), and provided with means (4) for holding each log (2) in a corresponding housing (30) and respectively releasing it;

means (5), disposed and acting between said entry plane (1) and said revolving unit (3), in order to transfer the logs (2) from the plane (1) to the revolving unit (3);

cutting means (6) for trimming the logs retained within the housings (30) of the revolving unit (3), that is, for removing portions thereof of reduced extension in correspondence of their ends;

a chute (7) downstream of the revolving unit (3), for unloading the trimmed logs (2′).

By way of example, and with reference to the drawings, the means (5) intended for loading the revolving unit (3), that is, for transferring the logs (2) from the plane (1) to the housings (30) of the revolving unit (3), comprise a body (52) which has square cross-section, developed in a direction parallel to that of incoming logs (2), is provided with peripheral seats (50) with L-shape profile (in the example, the seats 50 are in number of four and orthogonal to each other) and is mounted on a central shaft (51) associated with a corresponding driving motor (not shown in the drawings) to allow the rotation thereof about the respective longitudinal axis. The said body (52) is positioned on the respective shaft (51) in such a way that, while a wing (501) of a seat (50) is in line with the entry plane (1) of logs (2), a wing (502) of another seat (50) is in line with one of the housings (30) presented by the revolving unit (3).

Again with reference to the accompanying drawings, the means (4) for retaining the logs (2) within the housings (30) of the revolving unit (3) are gripper means. More in particular, the said means comprise a gripper for each housing (30), each gripper comprising two arcuate jaws, (40) associated with an actuator (41) via a connecting linkage (42). The said grippers are intended to retain the logs (2) by clamping them in proximity of their ends bases which project slightly from the housings provided by the revolving unit (3). For this purpose, the said grippers can be mounted on the bases (31) of the revolving unit (3).

As far as the cutting means (6) are concerned, they comprise, as shown in the drawings, two circular blades (60) located at a preset distance one from the other and acting on corresponding planes orthogonal to the longitudinal axis of each log (2) to be trimmed.

In the example, each blade (60) is associated with a relevant electric motor (61) via a drive belt (62). The motors (61) are disposed on supports (63) mounted on a horizontal guide (64) to allow at least one of them to be moved parallel to the logs (2) under treatment, and thus adjusting the position thereof, in relation to the length of the same logs (as indicated by the dual arrow “G”), by means of a corresponding adjustment handwheel (65). The blades (60) are mounted at the end of corresponding arms (66) which are cantilever-mounted with respect to the supports (63) of motors (61) and are able to pivot on hinges (660) parallel to the axes of the logs, that is, parallel to said guide (64), to allow the adjustment of the position of the blades (60) in the respective operating planes, as the same blades gradually wear out (with reduction of their diameter), by means of corresponding adjustment handwheels (67).

Also represented in the drawings are sharpening means with grinding wheels (68) in correspondence of blades (60) for the continuous sharpening of the latter during their rotation. The cutting tool for operating the trimming of the logs (2) can be of any type.

For example, with reference to FIG. 7, in place of said circular blades (60), band blades (600) may be used which are loop-closed on corresponding driving-out pulleys (601) and associated with two electric motors (602) each of which drives a corresponding pulley (601) into rotation.

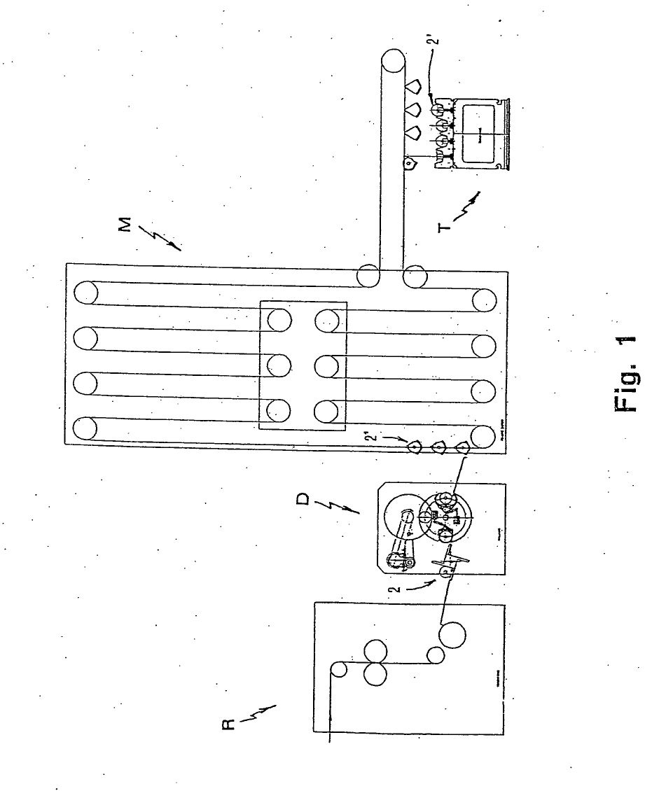

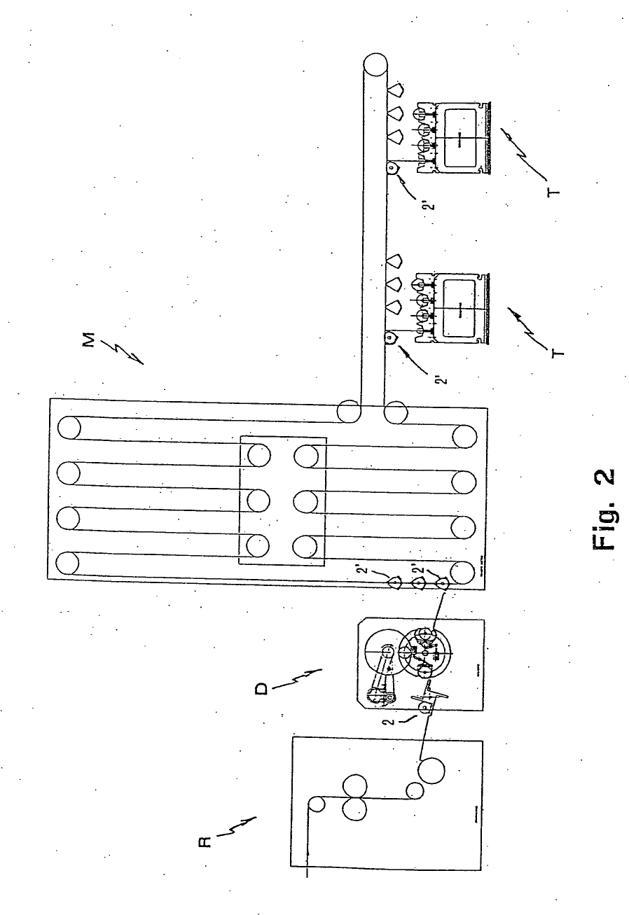

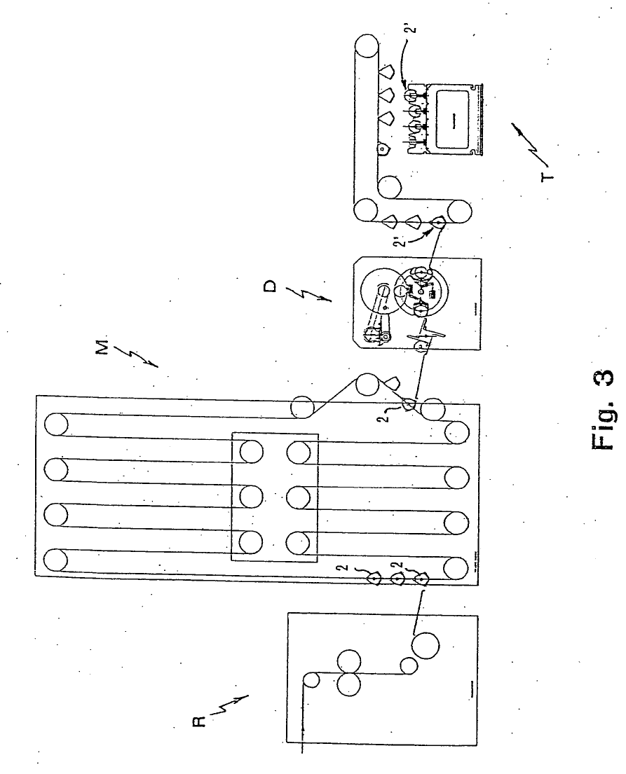

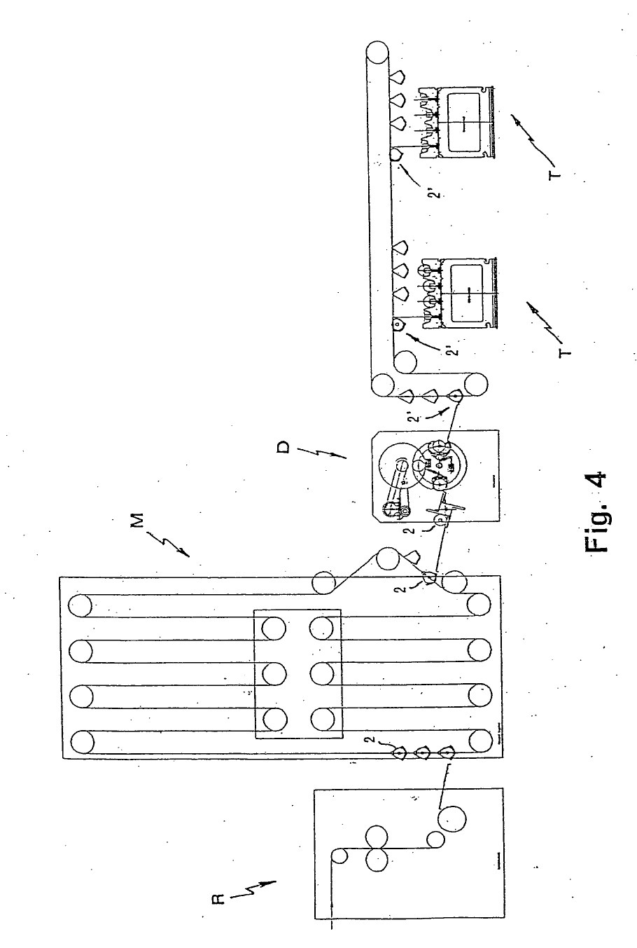

As illustrated in the schematic diagrams of FIGS. 1-4, an apparatus (D) according to the invention can be disposed both directly downstream of a rewinding machine (R) with associated means for closing the logs by glueing them—which machine is intended for the production of the logs (2)—as in FIGS. 1 and 2, and downstream of the a store (M) for the collection of logs, as in FIGS. 3 and 4.

In the first case, the trimmed logs (2′) are fed into the store (M) which is located downstream of the apparatus (D) and, downstream of store (M) there are disposed one (FIG. 1) or two (FIG. 2) cutting-off machines (T) which receive from the store (M) the already trimmed logs (2′) for dividing them into small rolls, that is, for dividing them into more elements of commercial size.

In the second case (FIGS. 3 and 4), the apparatus is disposed downstream of the store (M) and supplies one (FIG. 3) or two (FIG. 4) cutting-off machines (T).

In any case, the apparatus (D) is located upstream of one or more cutting-off machines (T) to which, therefore, come the already trimmed logs (2′).

The structure and operation of the rewinding machines, of the stores and the cutting-off machines for the logs, are known to those skilled in the art and, therefore, a more detailed description thereof is omitted.

The normal operating condition of the apparatus (D), reference being made to the drawings of FIGS. 5A-6, is as follows.

A log (2) to be trimmed runs along the plane (1) by rolling over it until it results disposed within a seat (50) of the body (52) in a stand-by condition (FIG. 5A). In this location a step of longitudinal positioning the log (2) takes place by means of pneumatic pushers (21) disposed in line with the log (2) and acting on the bases thereof, so that a reference of the same log (for example, a coloured line 22 or a figure printed on the paper of the logs) will result aligned with a fixed reference (e.g. one or more photo-transducers 23 located at a fixed position with respect to the body 52). At this point, the body (52) is rotated through 90°, so that the seat (50) of body (52) which houses the log will result in front of a housing (30) of the standing-by revolving unit (3) and, because of the inclination of the wing (502) of seat (52), the log (2) rolls towards and up to the housing (30) (FIG. 5B). Thereafter (FIG. 5C), the jaws (40) of the gripper associated with the housing (30) which now receives the log (2) clamp the latter (FIG. 5C) and the revolving unit revolves (arrow “H”) in order to dispose the log in the cutting position under the blades (60) (FIG. 5D). During said revolving of the unit (3) the trimming of the logs takes place with the removal of a reduced portion thereof in correspondence of both their ends, as schematically represented also in FIG. 6. By a further revolution of the unit (3), as indicated in FIG. 5E, the log (2′) thus trimmed is moved on in correspondence of the unloading chute (7), while the other housing (30) of the revolving unit (3) results in front of the body (52) which, in the meantime, has received another log (2) to be trimmed. At this point, the jaws of the gripper which retains the trimmed log (2′) open up, thereby releasing the log (2′) which can roll along the discharge plane (7) (FIG. 5F). The cycle is then repeated identically.

The said trimming step can be performed over a time longer than that spent for the same operation made by the common cutting-off machines. Besides, since the blades (60) are specifically intended for trimming the logs and not also for their cutting-off, the shape of the relevant chamfers can be chosen among those most suited for this specific work.

A process according to the invention provides in practice for supplying one or more cutting-off machines (T) with logs (2′) already trimmed, which can be made by having a log-trimming apparatus located upstream of the same cutting-off machines (T).

In this way, the small rolls produced by the cutting-off machines result with no trim to be separated and, since the logs (2′) fed to said machines are already trimmed, they have the desired constant dimensional and consistence characteristics in correspondence of their bases. In addition to this, the production of the trims (20) and, consequently, the collection thereof, takes place only in correspondence of the apparatus (D) and not also in correspondence of the cutting-off machines (T), thereby improving the trims-recover and disposal operations. Moreover, as it is possible to use cutting-off machines with no trimming and trim-removal means, the manufacturing of such machines is simpler and more economical.

Practically, the construction details may vary in any equivalent way as far as the shape, dimensions, elements disposition, nature of the used materials are concerned, without nevertheless departing from the scope of the adopted solution idea and, thereby, remaining within the limits of the protection granted to the present patent for industrial invention.

1) Apparatus for producing small paper rolls characterized in that it comprises:
a rewinding machined for producing elongated paper rolls or logs;
a trimming device for trimming each log produced by said rewinding machine
a store wherein the logs the logs already trimmed are stored;
at least a cutting-off machine for subdividing the logs already trimmed and supplied by said stored into a plurality of small rolls.

2) Apparatus for producing small paper rolls characterized in that it comprises:
a rewinding machine for producing elongated paper rolls or logs;
a store wherein said logs are stored;
a trimming device for trimming each log produced by said rewinding machine and supplied by said store;
at least a cutting-off machine for subdividing the logs already trimmed and supplied by trimming device.

3) Apparatus according to claim 1 characterized in that it comprises:
a section for the entry of the logs to be trimmed;
a section for the exit of the trimmed logs;
a station with cutting means for trimming the logs;
means for moving the logs between said entry section, said cutting station and said exit section;
means, associated with said log-moving means, for retaining the logs when subjected to said movement.

4) Apparatus according to claim 3 characterized in that the said log retaining means are gripper means.

5) Apparatus according to claim 3 characterized in that said gripper means are associated with said means for moving the logs.

6) Apparatus according to claim 3 characterized in that it comprises means, disposed and acting between said section for the entry and said means for moving the logs, in order to transfer the logs from the section to the means and in that said means for transferring the logs comprise a body, mounted on a shaft parallel to the logs which come-in through the entry section thereof, and provided with a plurality of seats for the logs to be transferred.

7) Method for producing a plurality of small rolls from paper rolls of logs characterized in that it comprises:
a first step of producing a paper roll or log;
a second step of trimming said log by removing a reduced portion thereof in correspondence of both its cods, thus obtaining a trimmed log:
a third step of storing said trimmed log into a store;
a fourth step of subdividing said trimmed log into a plurality of small rolls, said trimmed log being supplied by said store.

8) Method for producing a plurality of small rolls from paper rolls or logs characterized in that it comprises:
a first step of producing a paper roll or log;
a second step of storing said log into a store;
a third step of trimming said login a trimming station by removing a reduced portion thereof in correspondence of both its ends, thus obtaining a trimmed log;
a fourth step of subdividing said trimmed log into a plurality of small rolls, said subdividing step being carried out in a subdividing station separated by said trimming station.

9) Method for treating paper rolls or logs, comprising the steps of trimming off two reduced end portions from each log and of subdividing or cutting-off each log into more elements of smaller size, characterized in that the said trimming step is carried out upstream of where the cutting-off step is performed, said cutting-off step being performed by one or more cutting-off machines-M which are fed with logs already trimmed.

10) Method according to claim 9 characterized in that the said trimming step is carried out by an apparatus including:
a rewinding machine for producing elongated paper rolls or logs;
a trimming device for trimming each log produced by said rewinding machine;
a store wherein the logs the logs already trimmed are stored;
at least a cutting-off machine for subdividing the logs already trimmed and supplied by said store into a plurality of small rolls.

11) Method according to claim 9 characterized in that the said trimming step is carried out by a trimming machine downstream of a rewinding machine.
